(19) United States
(12) Patent Application Publication
(10) Pub. No.: US 2026/0113669 A1
(43) Pub. Date: Apr. 23, 2026

(54) SERVICE CONTINUITY FOR USER EQUIPMENT APPARATUS (UE) RECEIVING MULTICAST IN RADIO RESOURCE CONTROL (RRC) INACTIVE STATE

(71) Applicant: Nokia Technologies Oy, Espoo (FI)

(72) Inventors: Ugur Baran ELMALI, Munich (DE); Esa Mikael MALKAMÄKI, Espoo (FI); Subin NARAYANAN, Oulu (FI); Philippe GODIN, Massy (FR)

(21) Appl. No.: 19/475,170

(22) PCT Filed: Apr. 10, 2024
(86) PCT No.: PCT/EP2024/059695

§ 371 Date: Oct. 14, 2025

Related U.S. Application Data
(60) Provisional application No. 63/496,450, filed on Apr. 17, 2023.

(51) Int. Cl. H04W 36/00; H04W 4/06

(52) U.S. Cl. CPC H04W 36/0007; H04W 4/06

(57) ABSTRACT

Apparatus and methods for multicast service continuity for radio resource control (RRC) user equipment apparatuses (UEs) in mobility are disclosed. In an aspect, a UE receives, from a first network node of a first cell, a multicast service while operating in an RRC inactive state or an RRC idle state in the first cell. The UE further receives an indication of a packet data convergence protocol (PDCP) counter synchronization across multiple network nodes for the multicast service, where the multiple network nodes include the first network node. The UE further selects a second cell for camping. The UE further continues to receive, based on a PDCP variable continuity, the multicast service in the second cell from a second network node of the second cell, where the multiple network nodes include the second network node, and where the PDCP variable continuity is responsive to the indication of the PDCP counter synchronization.

### FIELD

Various example embodiments relate generally to wireless networking and, more particularly, to service continuity for user equipment apparatuses (UEs) receiving multicast in a radio resource control (RRC) inactive state.

### BACKGROUND

Wireless networking provides significant advantages for user mobility. A user's ability to remain connected while on the move provides advantages not only for the user, but also provides greater efficiency and productivity for society as a whole. As user expectations for connection reliability, data speed, and device battery life become more demanding, technology for wireless networking must also keep pace with such expectations. Accordingly, there is continuing interest in improving wireless networking technology.

### SUMMARY

In accordance with aspects of the present disclosure, a user equipment apparatus includes at least one processor; and at least one memory. The at least one memory storing instructions which, when executed by the at least one processor, cause the user equipment apparatus at least to receive, from a first network node of a first cell, a multicast service while operating in a radio resource control (RRC) inactive state in the first cell; receive an indication of a packet data convergence protocol (PDCP) counter synchronization across multiple network nodes for the multicast service, where the multiple network nodes include the first network node; select a second cell for camping; and continue to receive, based on a PDCP variable continuity, the multicast service in the second cell from a second network node of the second cell, where the multiple network nodes include the second network node, and where the PDCP variable continuity is responsive to the indication of the PDCP counter synchronization.

In an aspect of the present disclosure, the instructions when executed by the at least one processor, cause the user equipment apparatus at least to continue to receive the multicast service in the second cell by refraining, in response to the indication of the PDCP counter synchronization, from performing at least one of a PDCP re-establishment or an initialization of PDCP state variables in the second cell in association with the multicast service.

In an aspect of the present disclosure, the instructions when executed by the at least one processor, further cause the user equipment apparatus at least to determine, in response to the indication of the PDCP counter synchronization, the PDCP variable continuity, and the instructions when executed by the at least one processor, cause the user equipment apparatus at least to continue to receive the multicast service by applying the determined PDCP variable continuity to receive a packet associated with the multicast service.

In an aspect of the present disclosure, the instructions when executed by the at least one processor, cause the user equipment apparatus at least to receive the indication of the PDCP counter synchronization by receiving an indication of a logical channel identifier (LCID) mapping between at least the first network node and the second network node for the multicast service. The indication of the LCID mapping is the indication of the PDCP counter synchronization and implicitly indicates the PDCP counter synchronization across the multiple network nodes.

In an aspect of the present disclosure, instructions when executed by the at least one processor, cause the user equipment apparatus at least to continue to receive the multicast service in the second cell by applying, in response to receiving the LCID mapping, a PDCP counter of the first cell in the second cell to receive the multicast service.

In an aspect of the present disclosure, the indication of the LCID mapping indicates that a first LCID value associated with the first network node is mapped to a second LCID value associated with the second network node, and the instructions when executed by the at least one processor, cause the user equipment apparatus at least to continue to receive the multicast service in the second cell by receiving the multicast service via a logical channel identified by the second LCID value.

In an aspect of the present disclosure, the instructions when executed by the at least one processor, cause the user equipment apparatus at least to receive the indication of the PDCP counter synchronization by receiving, from the first network node before the selecting, the indication of the PDCP counter synchronization.

In an aspect of the present disclosure, the instructions when executed by the at least one processor, cause the user equipment apparatus at least to receive the indication of the PDCP counter synchronization by receiving, from the second network node after the selecting, the indication of the PDCP counter synchronization.

In an aspect of the present disclosure, the instructions when executed by the at least one processor, cause the user equipment apparatus at least to receive the indication of the PDCP counter synchronization by receiving the indication of the PDCP counter synchronization in an RRC release message.

In an aspect of the present disclosure, the instructions when executed by the at least one processor, cause the user equipment apparatus at least to receive the indication of the PDCP counter synchronization by receiving the indication of the PDCP counter synchronization in a multicast control channel (MCCH) configuration.

In accordance with aspects of the present disclosure, a method performed by a user equipment apparatus, the method including receiving, from a first network node of a first cell, a multicast service while operating in a radio resource control (RRC) inactive state in the first cell; receiving an indication of a packet data convergence protocol (PDCP) counter synchronization across multiple network nodes for the multicast service, where the multiple network nodes include the first network node; selecting a second cell for camping; and continuing to receive, based on a PDCP variable continuity, the multicast service in the second cell from a second network node of the second cell, where the multiple network nodes include the second network node, and where the PDCP variable continuity is responsive to the indication of the PDCP counter synchronization.

In an aspect of the present disclosure, the continuing to receive the multicast service in the second cell includes refraining, in response to the indication of the PDCP counter synchronization, from performing at least one of a PDCP re-establishment or an initialization of PDCP state variables (e.g., preserving all PDCP state variables of the first cell) in the second cell in association with the multicast service.

In an aspect of the present disclosure, the method further includes determining, in response to the indication of the PDCP counter synchronization, the PDCP variable continuity, and the continuing to receive the multicast service in the second cell includes receiving the multicast service via a logical channel identified by the second LCID value.

In an aspect of the present disclosure, the receiving the indication of the PDCP counter synchronization includes transmitting an indication of a logical channel identifier (LCID) mapping between at least the first network node and the second network node for the multicast service.

In an aspect of the present disclosure, the indication of the LCID mapping indicates that a first LCID value associated with the first network node is mapped to a second LCID value associated with the second network node, and the continuing to receive the multicast service in the second cell includes receiving the multicast service via a logical channel identified by the second LCID value. The indication of the LCID mapping is the indication of the PDCP counter synchronization and implicitly indicates the PDCP counter synchronization across the multiple network nodes.

In an aspect of the present disclosure, the receive the multicast service in the second cell includes applying, in response to receiving the LCID mapping, a PDCP counter of the first cell in the second cell to receive the multicast service.

In an aspect of the present disclosure, the receiving the indication of the PDCP counter synchronization includes receiving, from the first network node before the selecting, the indication of the PDCP counter synchronization.

In an aspect of the present disclosure, the receiving the indication of the PDCP counter synchronization includes receiving, from the second network node after the selecting, the indication of the PDCP counter synchronization.

In an aspect of the present disclosure, the receiving the indication of the PDCP counter synchronization includes receiving the indication of the PDCP counter synchronization in an RRC release message.

In an aspect of the present disclosure, the receiving the indication of the PDCP counter synchronization includes receiving the indication of the PDCP counter synchronization in a multicast control channel (MCCH) configuration.

In accordance with aspects of the present disclosure, a network node includes at least one processor; and at least one memory. The at least one memory storing instructions which, when executed by the at least one processor, cause the network node at least to determine that a packet data convergence protocol (PDCP) counter synchronization across multiple network nodes is applied for a multicast service, where the multiple network nodes include the network node; and transmit, to a user equipment apparatus (UE) in response to the determining, an indication of the PDCP counter synchronization across the multiple network nodes for the multicast service.

In an aspect of the present disclosure, the instructions when executed by the at least one processor, cause the network node at least to transmit the indication of the PDCP counter synchronization by transmitting an indication of a logical channel identifier (LCID) mapping between the network node and at least another network node of the multiple network nodes for the multicast service.

In an aspect of the present disclosure, the instructions when executed by the at least one processor, further cause the network node at least to determine, for the multicast service, an LCID mapping between the network node and the other network node.

In an aspect of the present disclosure, the instructions when executed by the at least one processor, cause the network node at least to transmit the indication of the PDCP counter synchronization by transmitting, to the UE, the indication of the PDCP counter synchronization in at least one of a multicast control channel (MCCH) configuration or a radio resource control (RRC) release message.

In an aspect of the present disclosure, the instructions when executed by the at least one processor, further cause the network node at least to exchange, with another network node of the multiple network nodes, logical channel identifier (LCID) information associated with the multicast service.

In an aspect of the present disclosure, the LCID information includes an indication of one or more quality of service flow identifiers (QFIs) mapped to an individual LCID associated with the multicast service.

In accordance with aspects of the present disclosure, a method performed by a network node, the method including determining that a packet data convergence protocol (PDCP) counter synchronization across multiple network nodes is applied for a multicast service, where the multiple network nodes include the network node; and transmitting, to a user equipment apparatus (UE) in response to the determining, an indication of the PDCP counter synchronization across the multiple network nodes for the multicast service.

In an aspect of the present disclosure, the transmitting the indication of the PDCP counter synchronization includes transmitting an indication of a logical channel identifier (LCID) mapping between the network node and at least another network node of the multiple network nodes for the multicast service.

In an aspect of the present disclosure, the method further includes determining, for the multicast service, an LCID mapping between the network node and the other network node.

In an aspect of the present disclosure, the transmitting the indication of the PDCP counter synchronization includes transmitting, to the UE, the indication of the PDCP counter synchronization in at least one of a multicast control channel (MCCH) configuration or a radio resource control (RRC) release message.

In an aspect of the present disclosure, the method further includes exchanging, with another network node of the multiple network nodes, logical channel identifier (LCID) information associated with the multicast service.

In an aspect of the present disclosure, the LCID information includes an indication of one or more quality of service flow identifiers (QFIs) mapped to an individual LCID associated with the multicast service.

According to some aspects, there is provided the subject matter of the independent claims. Some further aspects are defined in the dependent claims.

### BRIEF DESCRIPTION OF THE DRAWINGS

Some example embodiments will now be described with reference to the accompanying drawings.

FIG. 1 is a diagram of an example embodiment of wireless networking between a network system and a user equipment apparatus (UE), according to one illustrated aspect of the disclosure;

FIG. 2 is a diagram of an example embodiment of a UE in communications with a master node (MN) and a secondary node (SN), according to one illustrated aspect of the disclosure;

FIG. 3 is a diagram of an example embodiment of a multicast service continuity scenario for a radio resource control (RRC) inactive UE in mobility, according to one illustrated aspect of the present disclosure;

FIG. 4 is a diagram of an example embodiment of a network protocol architecture for providing multicast services, according to one illustrated aspect of the present disclosure;

FIG. 5 is a diagram of an example embodiment of operations for providing multicast service continuity to an RRC inactive UE in mobility, according to one illustrated aspect of the present disclosure;

FIG. 6 is a diagram of an example embodiment of operations for providing multicast service continuity to an RRC inactive UE in mobility, according to one illustrated aspect of the present disclosure;

FIG. 7 is a diagram of an example embodiment of operations for providing multicast service continuity to an RRC inactive UE in mobility, according to one illustrated aspect of the present disclosure;

FIG. 8 is a flow diagram of example operations of a UE for multicast service continuity, according to one illustrated aspect of the present disclosure;

FIG. 9 is a flow diagram of example operations of a network node for multicast service continuity, according to one illustrated aspect of the present disclosure; and

FIG. 10 illustrates an example embodiment of components of a UE or of a network node, according to one illustrated aspect of the present disclosure.

### DETAILED DESCRIPTION

In the following description, certain specific details are set forth in order to provide a thorough understanding of disclosed aspects. However, one skilled in the relevant art will recognize that aspects may be practiced without one or more of these specific details or with other methods, components, materials, etc. In other instances, well-known structures associated with transmitters, receivers, or transceivers have not been shown or described in detail to avoid unnecessarily obscuring descriptions of the aspects.

Reference throughout this specification to “one aspect” or “an aspect” means that a particular feature, structure, or characteristic described in connection with the aspect is included in at least one aspect. Thus, the appearances of the phrases “in one aspect” or “in an aspect” in various places throughout this specification are not necessarily all referring to the same aspect. Furthermore, the particular features, structures, or characteristics may be combined in any suitable manner in one or more aspects.

Embodiments described in the present disclosure may be implemented in wireless networking apparatuses, such as, without limitation, apparatuses utilizing Worldwide Interoperability for Microwave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), Long Term Evolution (LTE), LTE-Advanced, enhanced LTE (eLTE), 5G New Radio (5G NR), 5G Advance, 6G (and beyond) and 802.11ax (Wi-Fi 6), among other wireless networking systems. The term ‘eLTE’ here denotes the LTE evolution that connects to a 5G core. LTE is also known as evolved UMTS terrestrial radio access (EUTRA) or as evolved UMTS terrestrial radio access network (EUTRAN).

In wireless communication technologies, such as 5^{th} fifth-generation new radio (5G NR) as defined by 3rd Generation Partnership Project (3GPP), a network may provide multicast and broadcast system (MBS) services to users on the network. Point to multi-point (PTM) transmission may efficiently provision MBS services to multiple users by using the same radio framework as unicast transmission. In a wireless network, a user equipment apparatus (UE) may operate in various radio resource control (RRC) states, such as an RRC idle state, an RRC connected state, and an RRC inactive state. A UE in an RRC idle state is switched on but may not have any established RRC connection with the network. A UE in an RRC inactive state has established an RRC connection with the network, but the RRC connection is in a suspended mode (e.g., with no active data transfer in uplink (UL)). A UE in an RRC connected state has established an RRC connection with the network and has active data transfer over the RRC connection. A UE may transition from one RRC state to another RRC state under various conditions. As used herein, a UE operating in an RRC idle state may be referred to as an RRC idle UE, a UE operating in an RRC inactive state may be referred to as an RRC inactive UE, and a UE operating in an RRC connected state may be referred to as an RRC connected UE.

3GPP Release 17 (Rel-17) specifies broadcast reception in all RRC states. However, Rel-17 only enables reception of a multicast service by UEs in an RRC connected state. That is, Rel-17 does not support multicast service for UEs in an RRC inactive state.

A 5G NR protocol layer architecture may include various protocol layers, for example, including a service data adaptation protocol (SDAP) layer, a packet data convergence protocol (PDCP) layer, a radio link control (RLC) layer, a medium access control (MAC) layer, and a physical (PHY) layer. A UE may receive a multicast service via these protocol layers. A PDCP packet counter (called COUNT in NR) may be used to track and/or maintain sequence of packets associated with the multicast service. In this regard, each PDCP data service data unit (SDU) may be associated with a COUNT value. In an example, a PDCP packet counter may be formed from a combination of PDCP sequence number (PDCP SN) and hyper-frame number (HFN). Further, various PDCP variables (e.g., RX_NEXT, RX_DELIV, and RX_REORD in NR) may be used to facilitate the tracking of PDCP data reception. Such variables of the PDCP layer may be referred to as as state variables of PDCP or PDCP state variables.

Rel-17 may provision multicast service continuity across cells by applying PDCP counter synchronization among network nodes (e.g., base stations (BSs) or gNodeBs (gNBs) in the context of 5G NR) in a network for a multicast service. That is, each network node of at least a group of network nodes in the network may send the same piece of data of a multicast service using the same PDCP counter value (e.g., attached to the multicast service data packet). In this way, when a UE moves from one cell to another cell while operating in an RRC connected state (e.g., handover), the UE may continue to receive the same multicast service with a minimized packet loss. Such operation can be achieved by the UE asking for the missing packets, or detecting and discarding the packets that are received more than once, e.g., once from a source cell of a handover and once from a target cell of the handover.

To facilitate PDCP counter synchronization for a multicast service, a gNB (or more generally a network node) may set a counter, PDCP COUNT (which may correspond to a PDCP SN and an HFN derived from quality of service (QOS) flow sequence number(s) coming from a core network), in a way which is common for all gNBs in the system for providing that multicast service. Alternatively, a shared next-generation-user plane (NG-U) termination and/or shared central unit-user plane (CU-UP) may be used so that there is a single entity (e.g., CU-UP) that serves all the gNBs. Using the single entity to serve these gNBs can ensure PDCP COUNT/SN synchronization among these gNBs for the multicast service. As used herein, a PDCP counter may generally refer to the parameter PDCP COUNT and/or PDCP SN as defined by 3GPP.

To provide scalability and power saving, 3GPP Release 18 (Rel-18) enables reception of multicast services by UEs in an RRC inactive state. For instance, when a UE is in an RRC inactive state and is interested in a multicast service, the UE may apply a configuration of the multicast service in a cell to start and/or continue receiving the multicast service that the UE has joined. In an example, the configuration can be provided using a broadcast mode. For instance, the cell may broadcast system information block (SIB)/(multicast control channel) MCCH periodically so that the RRC inactive UE can receive the configuration and any updates to the configuration. Further, in some examples, the cell that configures the UE to transition from an RRC connected state to the RRC inactive state can provide such a configuration for the current cell in an RRC release message with a suspend configuration, which may be referred to as suspendConfig.

Multicast service continuity during UE mobility may not be an issue when a multicast service is only provided to UEs that are in an RRC connected state since the handover of a UE is known to the network, and thus minimization of packet loss for the multicast service can be managed by the network. For example, if the network nodes do not synchronize their PDCP counters, the UE can be configured with a new PDCP counter configuration in connection with a handover. Such counter configuration can be called PDCP re-establishment. In general, PDCP re-establishment may refer to resetting of the PDCP variables, e.g., PDCP state variables, to a new initial value. However, multicast service continuity may be problematic for a UE that is in an RRC inactive or idle state since the network may be unaware that the UE has selected a new cell for camping. As such, an RRC inactive UE is expected to minimize packet loss after camping onto a new cell.

One issue for an RRC inactive or idle UE in mobility is that the UE may be unaware of whether a PDCP counter synchronization is applied in a network (or in a neighboring cell). Therefore, the UE in the RRC inactive state may not know whether it can assume PDCP counter synchronization when selecting a new cell for camping or it has to establish a new PDCP counter for the new cell. Without knowing that a PDCP counter synchronization is applied in a newly selected cell, the UE may assume (by default) that no PDCP counter synchronization is applied in the new cell. As such, the UE may operate in the new cell by assuming MBS broadcast MBS radio bearers (MRB) behavior: release PDCP entities, read MCCH, and establish new PDCP entities/variables. Hence, no multicast service continuity can be achieved.

A multicast service or session may include a number of QoS flows that are mapped to radio bearers, which may be referred to as MBS radio bearers (MRBs). The MRBs are further mapped to logical channel identifiers (LCIDs) that are used by a UE to identify packets associated with the multicast service. Because different cells (or different network nodes) may use different MRBs for the same multicast service and may further independently map MRBs to LCIDs, a further issue for an RRC inactive UE in mobility is that the UE may be unaware of how MRBs of the source cell are mapped to MRBs of the target cell.

Accordingly, while PDCP counter synchronization may be applied across at least some network nodes (gNBs) in a network, an RRC inactive UE may be unable to achieve service continuity for multicast reception during mobility.

Aspects of the present disclosure provide techniques to enable multicast service continuity for RRC inactive UEs in mobility. According to an aspect of the present disclosure, a UE may receive a multicast service from a first network node (e.g., a base station, a gNB) of a first cell. The UE may receive the multicast service while operating in an RRC inactive state in the first cell. The UE may receive an indication of a PDCP counter synchronization is applied across multiple network nodes for the multicast service, where the multiple network nodes include the first network node. While camping on the first cell (e.g., operating in the RRC inactive state) and receiving the multicast service, the UE may select (or reselect) a second cell different than the first cell for camping. The cell selection (or reselection) may be based on signal measurements (e.g., RSRP measurements). For example, the UE may detect a degradation in signal quality from the first network node and may determine that the second cell provides a higher signal quality than the first cell. As a result of the cell selection, the UE will switch from receiving from the first cell to receiving from the second cell. While the UE is in the second cell (e.g., still operating in the RRC inactive or idle state), the UE may continue to receive the multicast service from a second network node of the second cell based on a PDCP variable continuity, where the multiple network nodes include the second network node. The UE may determine the PDCP variable continuity based on the indication of the PDCP counter synchronization.

In an aspect, the PDCP variable continuity may refer to the UE continuing to track a PDCP counter for data packets of the multicast service received in the second cell based on a last PDCP counter received in the first cell. That is, the RRC inactive UE may continue to receive the multicast service after moving to the second cell without performing a PDCP (re)establishment procedure in the second cell and a variable (e.g., at the UE) that tracks the PDCP counter is preserved (e.g., not being reset or discarded) during the move from the first cell to the second cell. In some aspects, the multiple network nodes may be part of a network, and the indication of the PDCP counter synchronization may include an indication that a PDCP counter is synchronized across all network nodes (e.g., all gNBs) in the network for providing the multicast service. In some aspects, the multiple network nodes may be part of a network, and the indication of the PDCP counter synchronization may include an indication that a PDCP counter is synchronized across some network nodes (e.g., some gNBs) but not all network nodes or certain network nodes in the network for providing the multicast service.

The PDCP counter synchronization may be understood to mean that the network nodes having their PDCP counters synchronized using the same PDCP counter for the same multicast service. It means that a data packet is associated with the same PDCP counter value when transmitted by the first cell and when transmitted by the second cell. From another perspective, the PDCP counter synchronization may be understood in such manner that different network nodes may use different PDCP counters that have a determined constant offset between the PDCP counters. The indication of the PDCP counter synchronization may then comprise an indication of such an offset between the first cell and the second cell, and the UE may then offset its PDCP counter accordingly when selecting the second cell without needing the PDCP reestablishment. Such synchronization may mean that the same PDCP COUNT or same PDCP SN value is used for transmitting the same data packet towards the air interface by different network nodes towards the UEs.

In some aspects, the UE may receive the PDCP counter synchronization including an indication of an LCID mapping between at least the first network node and the second network node. In an example, the multicast service may have two QoS flows, for example, one for audio and another one for video. The QoS flows may be provided over a certain MRB (e.g., a first MRB) in the first cell and the MRB may be mapped to a certain LCID (e.g., a first LCID) in the first cell. The LCID mapping may indicate a mapping between the first MRB of the first cell to a second MRB of the second cell and/or a mapping between the first LCID of the first cell to a second LCID of the second cell.

In some aspects, the UE may receive the indication of the PDCP counter synchronization from the first network node (before moving to the second cell). In some aspects, the UE may receive the indication of the PDCP counter synchronization from the second network node (while camping on the second cell). In some aspects, the UE may receive the indication of the PDCP counter synchronization in an RRC release message (e.g., as part of a suspend configuration in the RRC release message), for example, from the first network node and/or from the second network node (while operating in the second cell). In some aspects, the UE may receive the indication of the PDCP counter synchronization in a MCCH configuration, for example, from the first network node (while operating in the first cell) and/or from the second network node (while operating in the second cell).

According to another aspect of the present disclosure, a network node (e.g., a BS or a gNB) may determine that a PDCP counter synchronization is applied across multiple network nodes for a multicast service, where the multiple network nodes include the network node. The network node may operate under a certain public land mobile network (PLMN). Thus, such determining may be based on a configuration at the network node made by the Operations and Management (OAM) entity that is in control of the PLMN. The network node may transmit, to a UE in response to the determining, an indication of an LCID mapping across the multiple network nodes for the multicast service. The indication of the LCID mapping can be transmitted in an RRC release message and/or in a MCCH configuration. In some aspects, to determine the LCID mapping, the network node may exchange LCID information with another network node of the multiple network nodes. As part of exchanging the LCID information, the network node may transmit, to the other network node, LCID information of the network node in association with the multicast service's QOS flows (i.e., what QoS flows are mapping to which LCIDs in the current cell, indicating the QoS flow ID to LCID mapping) and receive, from the other network node, LCID information of the other network node in association with the multicast service. That way, the network node may determine the LCID mapping, of its own LCIDs to other network node's LCIDs, based at least in part on the LCID information of the other network node and its own LCID information.

Aspects of the present disclosure provide various advantages. For example, indicating the LCID mapping among multiple network nodes that are providing a multicast service can enable an RRC inactive UE to determine which radio bearer and/or which LCID to use for continuing to receive the multicast service when the RRC inactive UE moves to a new cell served by another network node of the multiple network nodes. As such, the present disclosure can provide multicast service continuity for RRC inactive UEs in mobility.

While the present disclosure describes multicast service continuity for RRC inactive UEs in mobility, aspects of the present disclosure are suitable for use to provide multicast service continuity for RRC idle UEs in mobility.

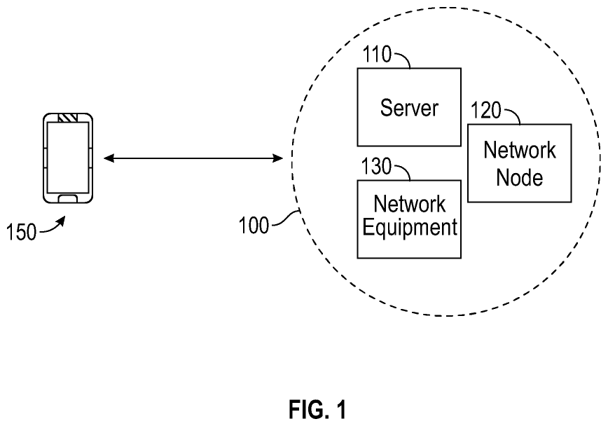

FIG. 1 is a diagram of an example embodiment of wireless networking between a network system 100 and a UE 150. The network system 100, for example, may include one or more network nodes 120, one or more servers 110, and/or one or more network equipment 130 (e.g., test equipment). The network nodes 120 will be described in more detail below. As used herein, the term “network apparatus” may refer to any component of the network system 100, such as the server 110, the network node 120, the network equipment 130, any component(s) of the foregoing, and/or any other component(s) of the network system 100. Examples of network apparatuses include, without limitation, apparatuses implementing 5G NR and apparatuses implementing Wi-Fi 6, among others. The present disclosure describes embodiments related to 5G NR and embodiments that involve aspects defined by 3GPP. However, it is contemplated that embodiments relating to other wireless networking technologies are encompassed within the scope of the present disclosure.

The following description provides further details of examples of network nodes. In a 5G NR network, a gNodeB (also known as gNB) may include, e.g., a node that provides NR user plane and control plane protocol terminations towards the UE and that is connected via a NG interface to the 5G core (5GC), e.g., according to 3GPP TS 38.300 V16.6.0 (2021-06) section 3.2, which is hereby incorporated by reference herein.

A gNB supports various protocol layers, e.g., Layer 1 (L1)-PHY layer, Layer 2 (L2), and Layer 3 (L3).

The layer 2 (L2) of NR is split into the following sublayers: MAC, RLC, and PDCP, and SDAP, where, e.g.:
The physical layer offers to the MAC sublayer transport channels;
The MAC sublayer offers to the RLC sublayer logical channels;
The RLC sublayer offers to the PDCP sublayer RLC channels;
The PDCP sublayer offers to the SDAP sublayer radio bearers;
The SDAP sublayer offers to 5GC QoS flows;

Layer 3 (L3) includes e.g., RRC, e.g., according to 3GPP TS 38.300 V16.6.0 (2021-06) section 6, which is hereby incorporated by reference herein.

In radio communications, a node may be implemented, at least partly, by a central unit (CU) (e.g., server or host) that is operationally coupled to one or more distributed units (DUs) (e.g., a radio head). In embodiments, it is possible that node operations may be distributed among multiple centralized units (e.g., servers or hosts). In embodiments, a network node in 5G wireless networking may be implemented based on a so-called CU-DU split. In embodiments, a processing task may be performed in either the CU or the DU, and the shifting of responsibility between the CU and the DU may be configurable according to a particular implementation.

A gNB central unit (gNB-CU) includes, e.g., a logical node hosting, e.g., RRC, SDAP, and PDCP protocols of the gNB or RRC and PDCP protocols of an enhanced LTE gNB (en-gNB), that controls the operation of one or more gNB distributed units (gNB-DUs). The gNB-CU terminates the F1 interface connected with the gNB-DU. A gNB-CU may also be referred to herein as a CU, a central unit, a centralized unit, or a control unit.

A gNB distributed unit (gNB-DU) includes, e.g., a logical node hosting, e.g., RLC, MAC, and PHY layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU. A gNB-DU may also be referred to herein as DU or a distributed unit.

A gNB-CU-Control Plane (gNB-CU-CP) includes, e.g., a logical node hosting, e.g., the RRC and the control plane part of the PDCP protocol of the gNB-CU for an en-gNB or a gNB. The gNB-CU-CP terminates the E1 interface connected with the gNB-CU-User Plane (gNB-CU-UP) and the F1-C interface connected with the gNB-DU.

A gNB-CU-User Plane (gNB-CU-UP) includes, e.g., a logical node hosting, e.g., the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U interface connected with the gNB-DU, e.g., according to 3GPP TS 38.401 V16.6.0 (2021-07) section 3.1, which is hereby incorporated by reference herein.

Different functional splits between the central and distributed units are possible, e.g., called options:
Option 1 (1A-like split):
   The function split in this option is similar to the 1A architecture in dual connectivity (DC). RRC is in the central unit. PDCP, RLC, MAC, physical layer, and radio frequency (RF) are in the distributed unit.
Option 2 (3C-like split):
   The function split in this option is similar to the 3C architecture in DC. RRC and PDCP are in the central unit. RLC, MAC, physical layer, and RF are in the distributed unit.
Option 3 (intra RLC split):
   Low RLC (partial function of RLC), MAC, physical layer, and RF are in the distributed unit. PDCP and high RLC (the other partial function of RLC) are in the central unit.
Option 4 (RLC-MAC split):
   MAC, physical layer, and RF are in the distributed unit. PDCP and RLC are in the central unit.
Or else, e.g., according to 3GPP TR 38.801 V14.0.0 (2017-03) section 11, which is incorporated by reference herein.

As used herein, the term “network node” may refer to any of a gNB, a gNB-CU, a gNB-DU, a gNB-CU-CP, or a gNB-CU-UP, or any combination of them.

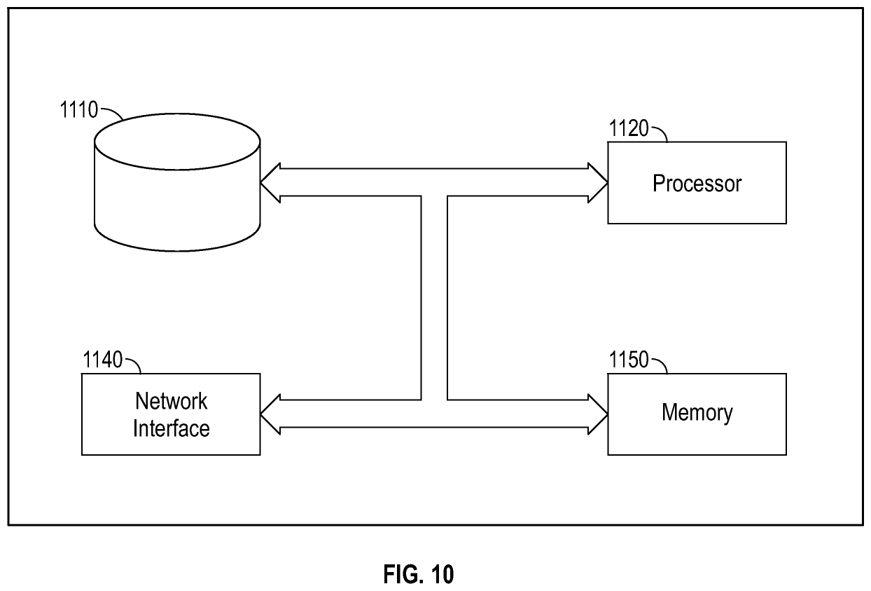

A radio access network (RAN) node or network node such as, e.g., a gNB, base station, gNB-CU, or gNB-DU, or parts thereof, may be implemented using, e.g., an apparatus with at least one processor and/or at least one memory with processor-readable instructions (“program”) configured to support and/or provision and/or process CU and/or DU related functionality and/or features, and/or at least one protocol (sub-)layer of a RAN (radio access network), e.g., layer 2 and/or layer 3. An example of such an apparatus and components will be described in connection with FIG. 10 below.

The gNB-CU and gNB-DU parts may, e.g., be co-located or physically separated. The gNB-DU may even be split further, e.g., into two parts, e.g., one including processing equipment and one including an antenna. A CU may also be called baseband unit (BBU), radio equipment control (REC), radio cloud center (RCC), cloud-RAN (C-RAN), virtual-RAN (V-RAN), open-RAN (O-RAN), or part thereof. A DU may also be called radio resource head (RRH), remote radio unit (RRU), radio equipment (RE), radio unit (RU), or part thereof. Hereinafter, in various example embodiments of the present disclosure, a network node, which supports at least one of central unit control plane functionality or a layer 3 protocol of a RAN, may be, e.g., a gNB-CU-CP. Similarly, a network node, which supports at least one of distributed unit functionality or a layer 2 protocol of the RAN, may be, e.g., a gNB-DU.

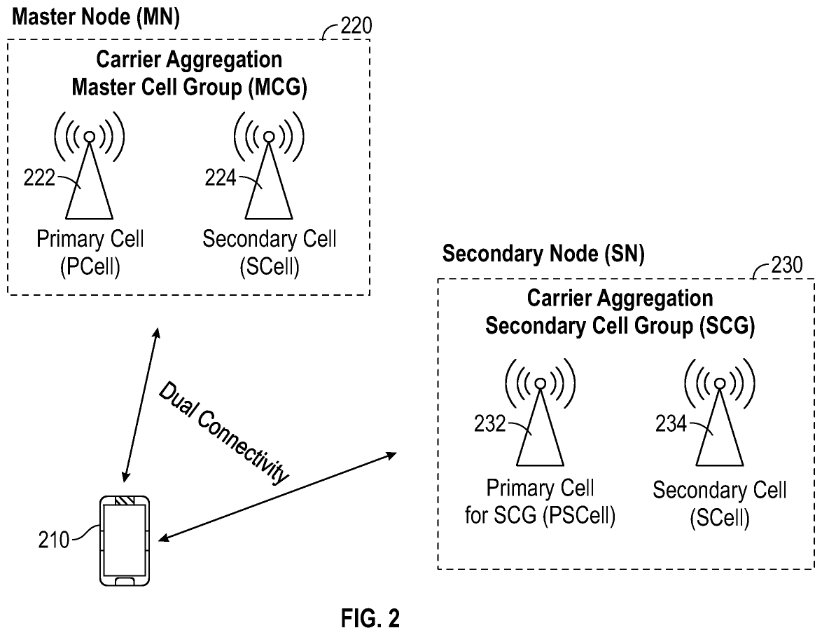

A gNB-CU may support one or multiple gNB-DUs. A gNB-DU may support one or multiple cells and, thus, could support a serving cell for a UE or support a candidate cell for handover, dual connectivity, and/or carrier aggregation, among other procedures. Examples of such procedures will be described below in connection with FIG. 2.

The UE 150 may be or include a wireless or mobile device, an apparatus with a radio interface to interact with a RAN (radio access network), a smartphone, an in-vehicle apparatus, an Internet of Things (IoT) device, or a M2M device, among other types of user equipment. Such UE 150 may include: at least one processor; and at least one memory including program code; where the at least one memory and the computer program code are configured to, with the at least one processor, cause the apparatus at least to perform certain operations, such as, e.g., RRC connection to the RAN. An example of components of a UE will be described in connection with FIG. 10. In embodiments, the UE 150 may be configured to generate a message (e.g., including a cell ID) to be transmitted via radio towards a RAN (e.g., to reach and communicate with a serving cell). In embodiments, the UE 150 may generate and transmit and receive RRC messages containing one or more RRC PDUs (packet data units). Persons skilled in the art will understand RRC protocol as well as other procedures a UE may perform.

With continuing reference to FIG. 1, in the example of a 5G NR network, the network system 100 provides a cell, which defines a coverage area of the network system 100. As described above, the network system 100 may include a gNB of a 5G NR network or may include any other apparatus configured to control radio communication and manage radio resources within a cell. As used herein, the term “resource” may refer to radio resources, such as a resource block (RB), a physical resource block (PRB), a radio frame, a subframe, a time slot, a sub-band, a frequency region, a sub-carrier, a beam, etc. In embodiments, the network node 120 may be called a base station and may communicate with the UE 150 using radio resources.

3GPP defines 5G NR frequency ranges, such as Frequency Range 2 (FR2) covering 24.25 GHz to 52.6 GHz, which include high frequencies and include bands having very high bandwidths that can accommodate high data rate use cases. Such bands may be subject to challenging propagating conditions, such as high path loss, absorption from the environment, and penetration losses, among other conditions. To address such conditions, beam management procedures may be used, such as using highly directive beams at the network node 120 and at the UE 150.

The network node 120 may transmit broadcast information, for example, including but not limited to, SSBs, SIBs, MCCHs, etc., to facilitate the UE 150 in accessing the network system 100 and receiving services (e.g., broadcast, multicast, and/or unitcast services) from the network system 100. The network node 120 may also transmit various reference signals, for example, including but not limited to, channel state information-reference signals (CSI-RSs), downlink-reference signals (DL-RSs), to facilitate channel measurements and reporting and/or beam search and management procedures.

The example of FIG. 1 is merely illustrative. Persons skilled in the art will understand that the network system 100 includes components not illustrated in FIG. 1 and will understand that other user equipment apparatuses may be in communication with the network system 100.

In some examples, it may be beneficial for a network to utilize dual connectivity and/or carrier aggregation to increase the bandwidth and bitrate for communication with UEs as will be discussed more fully below in connection with FIG. 2.

FIG. 2 is a diagram of an example embodiment a UE 210 in communications with an MN 220 and an SN 230. The UE 210 may be substantially similar to the UE 150 of FIG. 1. In embodiments, the MN 220 and/or the SN 230 may be a 5G NR node (e.g., gNB) or an LTE network node (e.g., eNB), among other types of nodes. In embodiments, the MN 220 and/or SN 230 may be BSs. The UE 210 may operate in a dual connectivity mode. Dual connectivity allows the UE 210 to simultaneously connect to two network nodes (e.g., the MN 220 and the SN 230 as shown).

In embodiments, the MN 220 connects to a core network, such as a 5G core (5GC), and provides a control plane connection between a UE 210 and the core network, while the SN 230 connects to the MN 220 (e.g., via an Xn interface) and provides additional resources for user plane traffic. In embodiments, the MN 220 handles signaling messages, such as RRC signaling messages. In embodiments, using signaling radio bearers (SRB) for LTE networks (e.g., SRB0, SRB1, and/or SRB2) and/or for 5G NR networks (e.g., SRB3), the SN 230 may handle signaling messages, such as RRC signaling messages, as well. As persons skilled in the art will understand, RRC is used by a node and a UE for various radio resource operations, such as, without limitation, connection management and mobility functions, among others. As used herein, the term “transmission” and/or “reception” may refer to, respectively, wirelessly transmitting and/or receiving via a wireless propagation channel on radio resources. Persons skilled in the art will understand RRC and SRB.

As further shown in the example of FIG. 2, carrier aggregation may be used in conjunction with dual connectivity. Carrier aggregation enables a UE 210 to simultaneously connect with multiple cells so as to operate at multiple frequencies at the same time. In embodiments, the multiple cells may be located at a single base station and/or at a common location (e.g., small cells or femtocells at a facility). One or more cells that may be usable by a UE under carrier aggregation may be referred to as a “cell group.” When carrier aggregation is used with dual connectivity, the MN and/or the SN may have a cell group. A cell group of a MN may be referred to as a master cell group (MCG), and a cell group of a SN may be referred to as a secondary cell group (SCG). The MCG includes a primary cell (PCell) and may include one or more secondary cells (SCell). The SCG includes a primary cell of a secondary cell group (PSCell) and may include one or more secondary cells (SCell). In the illustrated example of FIG. 2, the MN 220 includes one PCell 222 and one SCell 224. Similarly, the SN 230 includes one PCell 232 and one SCell 234. Each of the PCell 222, SCell 224, PCell 232, and SCell 234 may be operated by a network apparatus substantially similar to the network node 120 of FIG. 1. Persons skilled in the art will understand the characteristics and functions of such cells and cell groups.

The examples of FIG. 2 are merely illustrative. In embodiments, the number of PCells and SCells in an MN and/or in an SN may vary and may be different from those illustrated in FIG. 2.

As explained above, a UE may travel from one area to another area, and thus handover or mobility procedures can be important to support continue communication of the UE with the network. Further, a UE may receive a multicast service from a first cell while operating in an RRC state in the first cell and may select (or reselect) a second cell (new cell) for camping. It may be desirable for the RRC inactive UE to continue to receive the same multicast service while camping on the second cell.

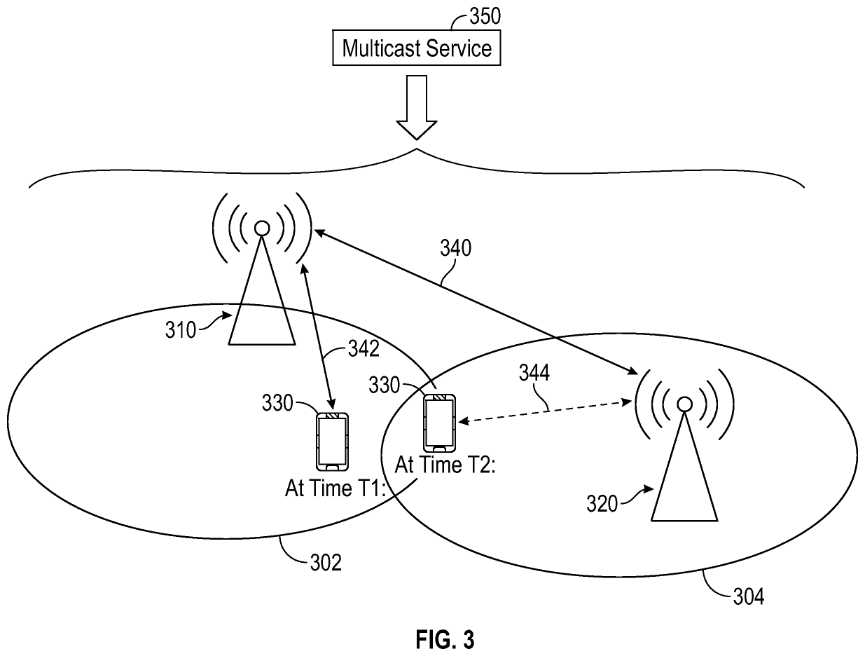

FIGS. 3-7 are discussed in relation to each other to illustrate various mechanisms for providing multicast service continuity to an RRC inactive UE in mobility.

FIG. 3 is a diagram of an example embodiment of a multicast service continuity scenario for an RRC inactive UE in mobility, according to one illustrated aspect of the present disclosure. As shown in FIG. 3, a UE 310 may be in communication with and served by a network node 320 (e.g., a base station, a gNB) as indicated by the solid arrow. The UE 310 may be substantially similar to the UE 150 of FIG. 1 and/or the UE 210 of FIG. 2. The network node 320 may be substantially similar to the network node 120 of FIG. 1 and/or the PCell 222, SCell 224, PCell 232, and SCell 234 of FIG. 2.

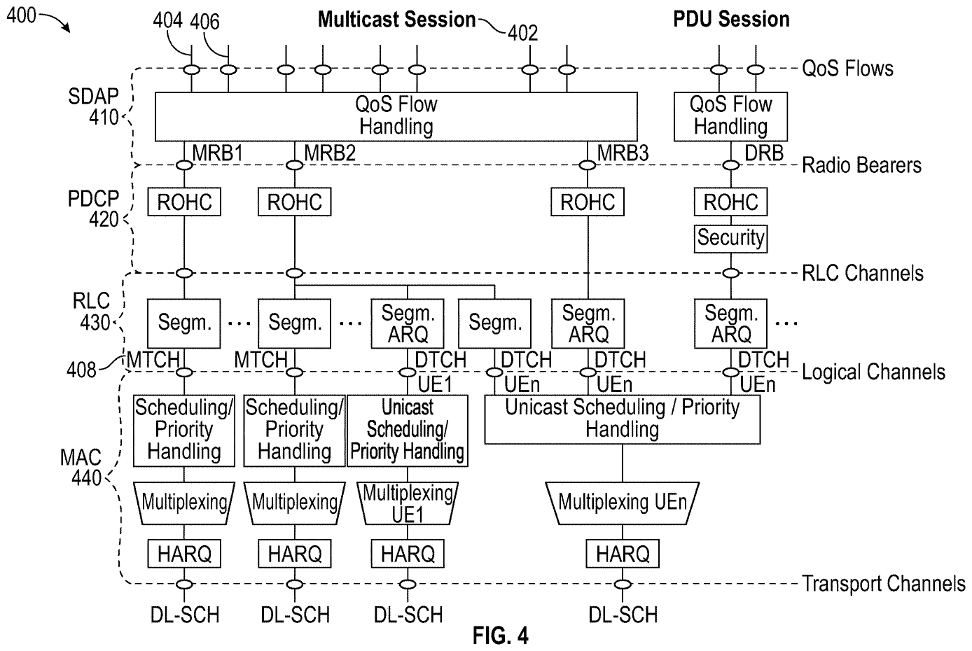

At time T1, the UE 310 may be within a cell 302 operated by the network node 320. The UE 310 may receive a multicast service 350 from the network node 320 via a communication link 342 while operating in an RRC inactive state in the cell 302. For instance, the UE 310 may have previously established an RRC connection with a network of the network node 320, but the RRC connection may be in a suspended mode. Further, the UE 310 may have performed a PDCP establishment procedure for receiving the multicast service 350. In an example, the network node 320 may utilize protocol layers (e.g., SDAP, PDCP, RLC, MAC, and PHY) as discussed above with reference to FIG. 1 and further below with reference to FIG. 4 to transmit the multicast service 350 to UEs (e.g., the UE 310) in the cell 302.

The network node 320 may include a PDCP entity that prepares data of the multicast service 350 for transmission in the form of PDCP packets where PDCP counter information (e.g., PDCP SN) are transmitted along with the data. For instance, the PDCP SN for each packet in a sequence of packets may be incremented by 1 in order. Another incrementation logic is equally possible. As an example, the network node 320 may transmit an n-th packet with an attached PDCP SN of N, a next packet (e.g., an (n+1)-th packet) with an attached PDCP SN of (N+1), a further next packet (e.g., an (n+2)-th packet) with an attached PDCP SN of (N+2), and so on. In this way, the UE 310 may determine whether a packet is missing or not based on a PDCP SN of a previously received packet and a PDCP SN of a next received packet. If a previously received packet has a PDCP SN of 4 and the next received packet has a PDCP SN of 5, there is no missing packet. If, however, a previously received packet has a PDCP SN of 4 and a next received packet has a PDCP SN of 6, there is one missing packet (the one with PDCP SN of 5). In some examples, when the UE 310 detects a missing packet, the UE 310 can request a retransmission of the missed packet.

In the illustrated example of FIG. 3, the UE 310 may be in mobility. For instance, at time T2, the UE 310 may travel to an edge of the cell 302. The UE 310 may autonomously select (or reselect) another cell 304 in the network for camping, for example, based on signal measurements in the cell 302. For instance, the UE 310 may detect a degradation in the signal quality (e.g., based on measurements such as layer 1 reference signal received power (RSRP)) from the cell 302, and thus may search for a neighboring cell (e.g., the cell 304) with a better signal quality for camping. In general, the UE 310 in the RRC inactive state may move to another cell within a radio access network (RAN) notification area (RNA) of the network while receiving the multicast service without notifying the network of the move.

According to an aspect of the present disclosure, the UE 310 may receive an indication of a PDCP counter synchronization across multiple network nodes (e.g., including the network node 320 of the cell 302 and a network node 330 of the cell 304) for the multicast service 350. That is, each network node of the multiple network nodes may attach the same PDCP counter information to the same piece of data of the multicast service 350 when transmitting that piece of data. Accordingly, the indication may indicate that the network nodes use the same PDCP counter for the multicast service 350. In one aspect, the indication of the PDCP counter synchronization can be received from the network node 320, for example, in a MCCH configuration or an RRC release message. In another aspect, the indication of the PDCP counter synchronization can be received from the network node 330, for example, in a MCCH configuration, after the UE 310 camped on the cell 304.

The UE 310 may determine a PDCP variable continuity based on the indication of the PDCP counter synchronization. The UE 310 may continue to receive the multicast service from the network node 320 via a communication link 344 while camping on (or operating in an RRC inactive or idle state in) the cell 304 based on the determined PDCP variable continuity. In this regard, the RRC inactive UE 310 may continue to receive the multicast service 350 after moving to the cell 304 without performing a PDCP establishment procedure in the cell 304 and a variable (e.g., local at the UE 310) that tracks the PDCP counter may be preserved (e.g., not being reset or discarded) during the move from the cell 302 to the cell 304. As an example, if a last packet of the multicast service 350 received by UE 310 from the network node 320 has a PDCP SN of a value K, the UE 310 may record the value K using the variable. After the UE 310 camped on the cell 304, the UE 310 may expect to receive, from the network node 330, a next packet of the multicast service 350 with a PDCP SN having a value (K+1). If the UE 310 receives, as the next packet of the multicast service 350 with a PDCP SN having a value (K+2) without first receiving a packet with the PDCP SN having the value (K+1), the UE is able to detect the missing packet because it has the information that the network nodes employ the same PDCP counter for the data packets. If the UE 310 receives, as the next packet of the multicast service 350 with a PDCP SN having a value (K), the UE is able to detect the duplicate packet and discard it.

In an aspect, the indication of the PDCP counter synchronization includes an indication that a PDCP counter is synchronized across all network nodes (including the network node 320 and the network node 330) in the network for the multicast service 350. In an aspect, the indication of the PDCP counter synchronization includes an indication that a PDCP counter is synchronized across some network nodes (including the network node 320 and the network node 330) in the network for the multicast service 350, but there is at least one network node in the network that does not apply the PDCP counter synchronization. Further, the indication of the PDCP counter synchronization can indicate one or more specific network nodes (e.g., gNB identifiers (IDs), cell IDs, etc.) that apply the PDCP counter synchronization. In an aspect, the indication of the PDCP counter synchronization includes an indication of an LCID mapping between the network node 320 and one or more other network nodes (e.g., the network node 330) in the network that are applied with the PDCP counter synchronization.

The examples of FIG. 3 are merely illustrative. In embodiments, the number of cells in a network and the number of UEs in a cell receiving a multicast service may vary and may be different from those illustrated in FIG. 3 FIG. 4 is a diagram of an example embodiment of a network protocol architecture 400 for providing multicast services, according to one illustrated aspect of the present disclosure. In an aspect, the network node 320 and/or the network node 330 of FIG. 3 may utilize the architecture 400 for providing the multicast service 350.

The architecture 400 may be part of a user plane of a Uu interface between a UE (e.g., the UE 310) and a gNB (e.g., the network nodes 320, 330). As shown in FIG. 4, the architecture 400 includes an SDAP sublayer 410, a PDCP sublayer 420, an RLC sublayer 430, and a MAC sublayer 440. While not shown, the architecture 400 further includes a PHY layer as discussed above with reference to FIG. 1. The PHY layer offers transport channels (shown as DL-SCH) to the MAC sublayer 440. The MAC sublayer 440 offers logical channels (shown as MTCH, DTCH) to the RLC sublayer 430. The RLC sublayer 430 offers RLC channels to the PDCP sublayer 420. The PDCP sublayer 420 offers MRBs (shown as MRB1, MRB2, . . . ) to the SDAP sublayer 410.

The MAC sublayer 440 may perform various functions, for example, including but not limited to, hybrid automatic repeat request (HARQ), multiplexing, and scheduling and/or priority handling. The RLC sublayer 430 may perform various functions, for example, including but not limited to, segmentation and automatic repeat request (ARQ). The PDCP sublayer 420 may perform various functions, for example, including but not limited to, maintenance of PDCP SNs, header compression and decompression using the robust header compression (ROHC) protocol. The SDAP sublayer 410 may perform various functions, for example, including but not limited to, mapping between a QoS flow and MRBs and marking QoS flow ID (QFI) in both downlink and uplink packets.

Persons skilled in the art will understand HARQ and scheduling and/or priority handling at the MAC sublayer 440, segmentation and ARQ at the RLC sublayer 430, maintenance of PDCP SNs and header compression and decompression at the PDCP sublayer 420, and mapping between a QoS flow and MRBs and marking QFI at the SDAP sublayer 410.

In an example, a multicast session 402 may include one or more QoS flows associated with one or more multicast services (e.g., the multicast service 350). In order not to clutter the drawing of FIG. 4, only two of QoS flows are labeled by 404 and 406. In an example, the multicast session 402 may be identified by a temporary mobile group identity (TMGI) assigned by a core network. The multicast session 402 may include multiple QOS flows (e.g., one QoS flow 404 for audio and another QoS flow 406 for video) for transporting data of a certain multicast service from the core network to a gNB (e.g., the network node 320 and/or the network node 330). The gNB may create a MRB (e.g., MRB1) for the QoS flows 404 and 406. The MRB1 may be identified by a certain MRB ID. The gNB may further map MRB1 to a logical channel 408, which may be identified by a certain LCID.

In an example, the network node 320 and the network node 330 may each map QoS flows (e.g., the QoS flows 404 and 406) of the multicast service 350 to an MRB (e.g., MRB1) separately and independently. Further, the network node 320 and the network node 330 may each map the MRB to an LCID separately and independently. Consequently, the same QoS flow for the multicast service 350 can be mapped to different MRB IDs and/or different LCIDs at different network nodes. There is generally a one-to-one mapping between MRBs and LCIDs at a particular network node.

As an example, the network node 320 (in the cell 302) may map the QoS flow 404 and QOS flow 406 to MRB ID 1 and LCID 3 while the network node 330 (in the cell 304) may map the QoS flow 404 and QoS flow 406 to an MRB with an MRB ID 4 and an LCID 2. As such, to facilitate multicast service continuity for RRC inactive UEs, the network node 320 and/or the network node 330 may provide the UE 310 with an LCID mapping for the multicast service 350. The LCID mapping may include an indication that LCID 3 at the network node 320 is mapped to (or correspond to) LCID 2 of the network node 330. Additionally or alternatively, the LCID mapping may further include an indication that MRB ID 1 at the network node 320 is mapped to (or correspond to) to MRB ID 4 of the network node 330. To facilitate the LCID mapping, the network node 320 and the network node 330 may exchange LCID information over a communication link 340 (e.g., an Xn interface). While performing such exchange, they can indicate which LCID is mapped to which QoS flow ID (assigned by a core network, thus, common for all gNBs). In this way, the network nodes 320 and/or 330 may each determine an LCID mapping between the network nodes 320 and 330 for the multicast service 350 based on the exchanged LCID information.

The examples of FIG. 4 are merely illustrative. In embodiments, the mappings from one protocol layer to another protocol layer may vary and may be different from those illustrated in FIG. 4.

In general, if synchronization of PDCP COUNT/SNs is applied in the network, the RAN nodes (e.g., network nodes 120, 320 and 330 and the network nodes of the PCell 222, SCell 224, PCell 232, and SCell 234) are configured with the information that the PDCP counter synchronization is applied in the network (or at least at some part of the network, e.g., neighbors of a particular RAN node). In an aspect, RAN nodes may inform a UE (e.g., the UEs 150, 210, 310) about such a configuration. Informing can take place via an indication (e.g., a PDCP counter synchronization indication) to UEs that is broadcast over an MCCH channel or sent to individual UEs within an RRC release message with suspendConfig.

In a first aspect, the PDCP counter synchronization indication may indicate that a PDCP COUNT/SN synchronization is applied to all gNBs of a network (e.g., a PLMN). In a second aspect, the PDCP counter synchronization indication may indicate that a PDCP COUNT/SN synchronization is applied to one particular cell or gNB (per neighboring cell or neighbor gNB information (e.g., cell 1 and 2 are in sync)). In a third aspect, the PDCP counter synchronization indication may indicate that a PDCP COUNT/SN is not in sync between gNBs. In some aspects, a UE may assume that PDCP COUNT/SNs are synchronized among gNBs in a network unless an indication that the PDCP COUNT/SN synchronization is not applied. In a fourth aspect, the PDCP counter synchronization indication may include mappings of LCIDs in a source cell (e.g., the cell 302) to neighboring cells (the cell 304). As LCID has 1-to-1 mapping with MRBs, the UE can map the source cell's MRBs to the target cell's MRBs to achieve service continuity, if the gNBs have PDCP COUNT/SNs synchronized. In general, a PDCP counter synchronization indication can include the LCID mapping in combination with the first aspect or the second aspect.

In some aspects, the signaling of an LCID mapping to a UE may be an implicit indication that PDCP COUNT/SNs are synchronized among cells in the network. Accordingly, upon receiving the indication of the LCID mapping between the first cell and the second cell, the UE may implicitly determine that the first cell and the second cell use the same PDCP counter for the data packets and continue to use the same PDCP counter after the cell selection. Therefore, no explicit indicator indicating the PDCP counter synchronization is needed in this embodiment.

In an aspect, when a UE operating in an RRC inactive states knows that the source cell on which the UE was camping and the target cell to which the UE reselected have PDCP COUNT/SN synchronization, the UE may not re-establish the PDCP entity upon entering the target cell. The UE may determine a PDCP variable continuity (e.g., continuity of a PDCP COUNT and/or a PDCP SN) from the source cell to the target cell. The UE may keep continuing the multicast service reception when reselecting to the target cell if the multicast service is also provided to UEs in an RRC inactive state in the target cell. When the UE knows otherwise, i.e., no PDCP COUNT/SN is synchronized among gNBs, the UE may re-establish the PDCP entity in the target cell.

In an aspect, LCID mappings for a multicast service may be signaled by broadcast over a MCCH by the gNB. In an aspect, to enable one gNB to learn about neighbor gNBs'LCIDs, LCID information may be exchanged over an Xn interface (e.g., the communication link 340) among gNBs. The exchanged LCID information can include a list of QFIs (e.g., for the QoS flows 404 and 406) that are mapped to a certain LCID in association with the multicast service at a particular gNB. Accordingly, each gNB may determine an LCID mapping between its own LCID and each neighboring gNB's LCID in association with the multicast service.

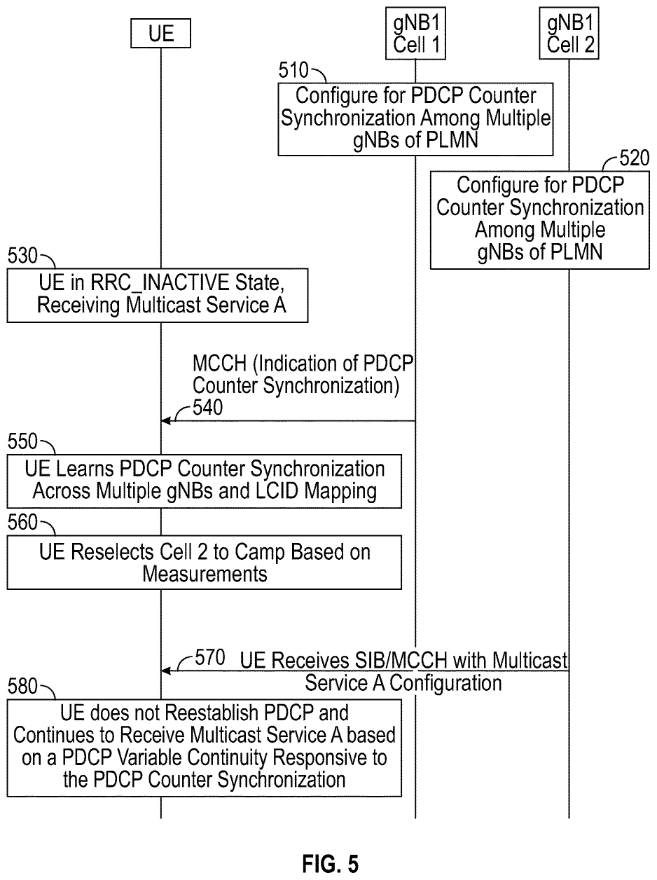

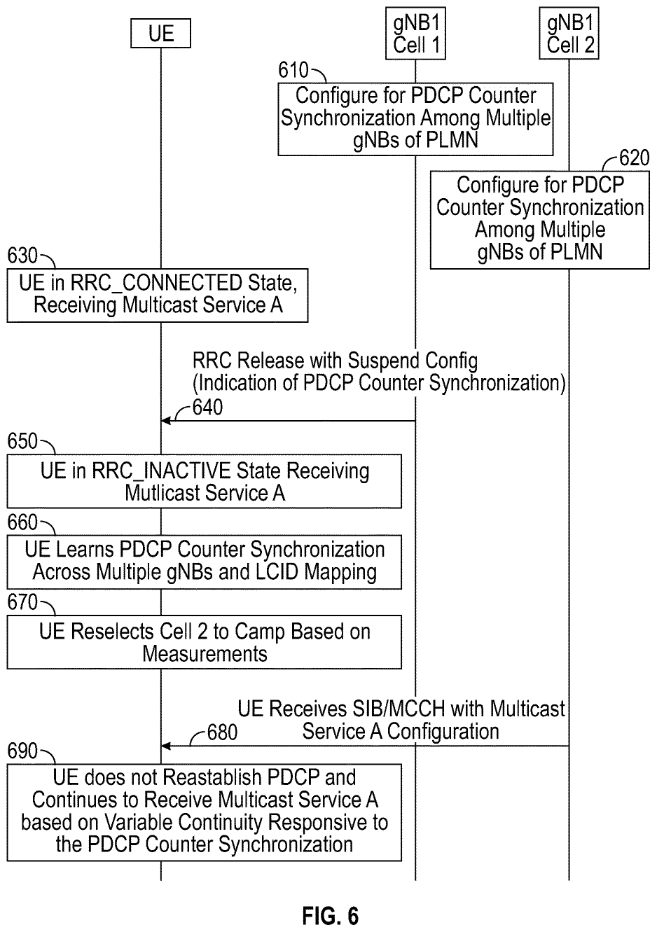

In general, an RRC inactive UE in mobility may receive information related to PDCP counter synchronization for a multicast service in a variety of ways, for example, in an RRC release message and/or in an MCCH configuration, from a gNB of a source cell or from a gNB of a target cell as will be discussed more fully below with reference to FIGS. 5 and 6.

FIG. 5 is a diagram of an example embodiment of operations for providing multicast service continuity to an RRC inactive UE in mobility, according to one illustrated aspect of the present disclosure. The operations are implemented among a UE, gNB 1 serving a cell 1, and gNB 2 serving cell 2. In an aspect, the UE, gNB 1, cell 1, gNB 2, and cell 2 correspond to the UE 310, the network node 320, the cell 302, the network node 330, and the cell 304, respectively. In some examples, each of the UE, gNB 1, and gNB 2 may implement the operations using an apparatus with components as shown in FIG. 10. One or more of the following operations may be implemented in connection with the operations of the present disclosure, such as the examples discussed above with reference to FIGS. 1-4. As illustrated, FIG. 5 includes a number of enumerated steps, but aspects of the operations in FIG. 5 may include additional steps before, after, and in between the enumerated steps. In some aspects, one or more of the enumerated steps may be omitted or performed in a different order.

At 510, gNB 1 is configured for PDCP counter synchronization among multiple gNBs of a PLMN (or generally a network) for providing a multicast service A (e.g., the multicast service 350). The multiple gNBs may include at least gNB 1 and gNB 2. In general, gNB 1 may be configured with the information that synchronization of a PDCP counter with one or more other gNBs of the PLMN is applied. In some examples, gNB 1 is configured with the information that synchronization of a PDCP counter with all gNBs of the PLMN in association with the multicast service A is applied. In an aspect, gNB 1 is configured with the information that synchronization of a PDCP counter with some gNBs of the PLMN but not all gNBs of the PLMN in association with the multicast service A is applied. In an aspect, gNB 1 is configured with the information that synchronization of a PDCP counter with some cell IDs of the PLMN in association with the multicast service A is applied. In an example, gNB1 is configured for the PDCP counter synchronization by an operator, an OAM of the PLMN, etc. In other examples, the configuration for PDCP counter synchronization can be preconfigured at gNB 1.

At 520, gNB 2 is configured for PDCP counter synchronization among multiple gNBs of a PLMN in providing a multicast service A (e.g., the multicast service 350) in a similar way as for gNB 1 at 510. In general, gNB 2 may be configured with the information that synchronization of a PCDP counter with one or more other gNBs of the PLMN is applied. In an example, gNB 2 is configured for the PDCP counter synchronization by the operator, the OAM of the PLMN, etc. In other examples, the configuration for PDCP counter synchronization can be preconfigured at gNB 2.

At 530, the UE operates in an RRC inactive state in cell 1 and receives the multicast service A from gNB 1 while operating in the RRC inactive state. In an example, the UE may have performed a PDCP establishment procedure with gNB 1 for receiving the multicast service A. In an example, gNB 1 may create an MRB for one or more QoS flows (e.g., the QoS flows 404 and 406) of the multicast service A and may map the MRB to a logical channel identified by a certain LCID as discussed above with reference to FIG. 3. Further, a PCDP entity at the gNB 1 may transmit data of the multicast service A along with a PDCP counter (e.g., a PDCP SN) to enable tracking of missing packet in the reception at the UE as discussed above with reference to FIG. 3.

At 540, gNB 1 transmits, and the UE receives a broadcast a MCCH configuration including an indication of a PDCP counter synchronization among multiple gNBs (e.g., including at least gNB 1 and gNB 2) for the multicast service A.

In an aspect, the MCCH configuration may include information indicating that PDCP COUNT/SNs are synchronized among the PLMN (e.g., all gNBs in the PLMN). The indication may be a one-bit flag. For instance, the flag may be set to a value of 1 to indicate that a PDCP counter synchronization is applied in the PLMN or set to a value of 0 to indicate that a PDCP counter synchronization is not applied in the PLMN, or vice versa.

In an aspect, the MCCH configuration may include information indicating that PDCP COUNT/SNs are synchronized among some gNBs of the PLMN but not all gNBs of the PLMN. In an example, the information may include a list of neighbor gNBs and/or neighboring cells with PDCP COUNT/SNs synchronized for the multicast service A.

In an aspect, the MCCH configuration may include a mapping of LCIDs of cell 1 with neighboring cells'LCIDs (e.g., LCIDs of cell 2). For instance, the RRC release message may indicate that LCID 1 of cell 1 is mapped to LCID 5 of cell 2 in association with the multicast service A.

At 550, the UE learns (or determines) that PDCP COUNT/SNs are synchronized among all gNBs of the PLMN or among some gNBs of the PLMN, for example, based on the information in the MCCH configuration received at 540. The UE can also learn the LCID mapping of MRBs in cell 1 (a source cell) and neighboring cells (e.g., cell 2) based on the information in the MCCH configuration received at 540. For instance, the UE may learn that MRB 1 in cell 1 for providing the multicast service A is mapped to MRB 4 in cell 2 for providing the multicast service A. Further, the UE may learn that MRB 1 is mapped to LCID 2 in cell 1, and MRB 4 is mapped to LCDI 5 in cell.

At 560, the UE selects (or reselects) a new cell (cell 2) to camp based on signal measurements (e.g., RSRPs). The UE may continue to operate in an RRC inactive state in cell 2.

At 570, gNB 2 transmits, and the UE receives SIBs and MCCH configurations of cell 2. The UE learns about a configuration for the multicast service A. For instance, gNB 2 transmits the SIBs and/or the MCCH configurations periodically, where a SIB may indicate scheduling information (e.g., time and/or frequency locations) of the MCCH configurations. Thus, the UE may read the SIBs from gNB 2 and monitor for the MCCH configurations according to the scheduling information. Upon reading the MCCH configuration(s), the UE may learn how to receive the multicast service A.

At 580, the UE does not re-establish PDCP (upon entering cell 2) and continues to receive multicast service A via information in the MCCH configuration received at 540 based on a PDCP variable continuity. Stated differently, the UE may refrain from performing a PDCP establishment procedure in cell 2 and continue to use a PDCP entity that was established in cell 1.The PDCP variable continuity is responsive to the indication of PDCP counter synchronization. In this regard, the UE may map MRBs in the source cell (cell 1) to MRBs in the target cell (cell 2). Referring to the same example provided at 550, the UE may determine that the multicast service A is provided via MRB 4 mapped to LCID 5 in cell 2. Accordingly, the UE may continue to receive data of the multicast service A from a logical channel identified by LCID 5 in cell 2. The UE may assume that the PDCP COUNT and/or the PDCP SN may continue from a last respective PDCP COUNT and/or PDCP SN received from cell 1. Further, as part of continuing to receive the multicast service in the second cell, the UE refrains from performing an initialization of PDCP state variables. That is, the UE may keep the values of all PDCP state variables (e.g., RX_NEXT, RX DELIV, and RX_REORD in NR) of the first cell.

In an aspect, operations at 540, 550, and 570 may be performed after the UE reads SIBs and/or MCCH configurations at 540 from gNB 2 of cell 2. In other words, PDCP synchronization related information is checked by the UE in the target cell (cell 2), rather than in the source cell (cell 1).

In an aspect, enabling multicast reception to UEs in an RRC inactive state is a per cell decision. Therefore, in some scenarios, the UE may not find the multicast service A being provided to the UE in the RRC active state after reading the MCCH configuration at 570. In such scenarios, the UE may reconnect to receive the multicast service A in an RRC connected state. In an aspect, the UE may receive, from gNB 1, an indication that a neighboring cell (e.g., cell 2) does not support multicast service for RRC inactive UEs. In an aspect, the UE may receive, from gNB 1, an indication that a neighboring cell (e.g., cell 2) does not provide the multicast service A to any UEs as there is no UE that has joined the multicast session for the multicast service A in cell 2.

FIG. 6 is a diagram of an example embodiment of operations for providing multicast service continuity to an RRC inactive UE in mobility, according to one illustrated aspect of the present disclosure. The operations are implemented among a UE, gNB 1 serving a cell 1, and gNB 2 serving cell 2. In an aspect, the UE, gNB 1, cell 1, gNB 2, and cell 2 correspond to the UE 310, the network node 320, the cell 302, the network node 330, and the cell 304, respectively. In some examples, each of the UE, gNB 1, and gNB 2 may implement the operations using an apparatus with components as shown in FIG. 10. One or more of the following operations may be implemented in connection with the operations of the present disclosure, such as the examples discussed above with reference to FIGS. 1-5. As illustrated, FIG. 6 includes a number of enumerated steps, but aspects of the operations in FIG. 6 may include additional steps before, after, and in between the enumerated steps. In some aspects, one or more of the enumerated steps may be omitted or performed in a different order.

Generally speaking, the operations of FIG. 6 include features similar to the operations of FIG. 5 in many respects. For example, operations at steps 610, 620, 660, 670, 680, and 690 are similar to operations at 510, 520, 550, 560, 570, and 580, respectively. Accordingly, for brevity, details of those steps will not be repeated here and can be refer to the corresponding descriptions above.

At 630, the UE operates in an RRC connected state in cell 1 and receives the multicast service A from gNB 1 while operating in the RRC connected state.

At 640, gNB 1 transmits, and the UE receives an RRC release message with a suspend configuration, suspendConfig. That is, the UE is released (or transition) to an RRC inactive state.

In an aspect, the RRC release message may include information indicating that PDCP COUNT/SNs are synchronized among the PLMN (e.g., all gNBs in the PLMN). The indication may be a one-bit flag. For instance, the flag may be set to a value of 1 to indicate that a PDCP counter synchronization is applied in the PLMN or set to a value of 0 to indicate that a PDCP counter synchronization is not applied in the PLMN, or vice versa.

In an aspect, the RRC release message may include information indicating that PDCP COUNT/SNs are synchronized among some gNBs of the PLMN but not all gNBs of the PLMN. In an example, the information may include a list of neighbor gNBs and/or neighboring cells with PDCP COUNT/SNs synchronized for the multicast service A.

In an aspect, the RRC release message may include a mapping of LCIDs of cell 1 with neighboring cells'LCIDs (e.g., LCIDs of cell 2). For instance, the RRC release message may indicate that LCID 1 of cell 1 is mapped to LCID 5 of cell 2 in association with the multicast service A.

At 650, the UE is in an RRC inactive state in response to the RRC release message. The UE receives the multicast service A from gNB 1 while operating in the RRC inactive state in cell 1.

Operations at 660 are substantially similar to the operations at 550, but the UE may learn (or determine) PDCP counter synchronization and/or LCID mapping information among the network or some network nodes in association with multicast service A based on information in the RRC release message received at 640 instead of in a MCCH configuration as in FIG. 5.

While operations of FIGS. 5 and 6 are discussed in the context of the RRC inactive UE receiving the multicast service A during mobility, aspects are not limited thereto. For example, an RRC idle UE in cell 1 may also receive the multicast service A, receive the indication of the PDCP counter synchronization, select cell 2 for camping, and continue to receive the multicast service A while in cell 2 using the same mechanisms as the RRC inactive UE discussed above.

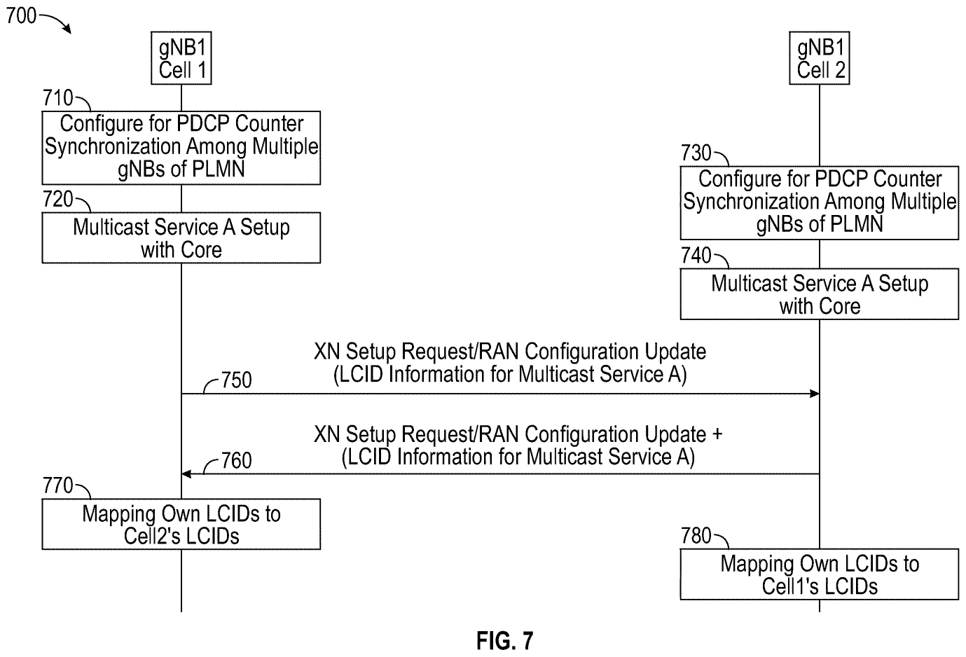

FIG. 7 is a diagram of an example embodiment of operations for providing multicast service continuity to an RRC inactive UE in mobility, according to one illustrated aspect of the present disclosure. The operations are implemented among gNB 1 serving cell 1, and gNB 2 serving cell 2. In an aspect, gNB 1, cell 1, gNB 2, and cell 2 correspond to the network node 320, the cell 302, the network node 330, and the cell 304, respectively. In another aspect, gNB 1, cell 1, gNB 2, and cell 2 correspond to the network node 330, the cell 304, the network node 320, and the cell 302, respectively. In some examples, each of gNB 1 and gNB 2 may implement the operations using an apparatus with components as shown in FIG. 10. One or more of the following operations may be implemented in connection with the operations of the present disclosure, such as the examples discussed above with reference to FIGS. 1-6. As illustrated, FIG. 7 includes a number of enumerated steps, but aspects of the operations in FIG. 7 may include additional steps before, after, and in between the enumerated steps. In some aspects, one or more of the enumerated steps may be omitted or performed in a different order.

At 710, gNB 1 is configured for PDCP counter synchronization among multiple gNBs of a PLMN (or generally a network) for providing a multicast service A (e.g., the multicast service 350). The multiple gNBs may include at least gNB 1 and gNB 2. In general, gNB 1 may be configured with the information that synchronization of a PCDP counter with one or more other gNBs of the PLMN is applied. In some examples, gNB 1 may be configured with the information that synchronization of PDCP counter with all gNBs of the PLMN in association with the multicast service A. In an aspect, gNB 1 is configured with the information that synchronization of a PDCP counter with some gNBs of the PLMN but not all gNBs of the PLMN in association with the multicast service A is applied. In an aspect, gNB 1 is configured with the information that synchronization of a PDCP counter with some cell IDs of the PLMN in association with the multicast service A is applied. In an example, gNB1 is configured for the PDCP counter synchronization by an operator, an OAM of the PLMN, etc. In other examples, the configuration for PDCP counter synchronization can be preconfigured at gNB 1.

At 720, gNB 1 performs setup for the multicast service A (e.g., the multicast service 350) with a core network. Setup may include communication with the core network of the PLMN to retrieve the information, e.g., QoS information, to provide the multicast service in one of the cells of the gNB 1. Such setup may also include retrieval of the relevant data from the core network to provide it over the air towards the UEs. Such setup is initiated by the gNB towards the core network once there is a UE context that indicates a UE has joined a multicast session.

At 730, gNB 2 is configured for PDCP counter synchronization among multiple gNBs of a PLMN in providing a multicast service A (e.g., the multicast service 350) in a similar way as for gNB 1 at 510. In general, gNB 2 may be configured with the information that synchronization of a PCDP counter with one or more other gNBs of the PLMN is applied. In an example, gNB2 is configured for the PDCP counter synchronization by an operator, an OAM of the PLMN, etc. In other examples, the configuration for PDCP counter synchronization can be preconfigured at gNB 2.

Operations at 710 and 730 may be substantially similar to the operations at 510, 520, 610, and 620.

At 740, gNB 2 performs setup for the multicast service A (e.g., the multicast service 350) with a core network.

In an example, a multicast session is ongoing for the multicast service A respectively at gNB 1 (based on the setup at 720) and gNB 2 (based on the setup at 740).

At 750, gNB 1 transmits, and gNB 2 receives LCID information of cell 1 in association with the multicast service A, along with a mapping of LCID to QFIs. In general, gNB 1 may transmit the LCID information to each neighboring cell of gNB 1, and a mapping of those to QFIs. The LCID information may include, for each multicast session (e.g., the multicast service A) at gNB 1, a list of LCID(s) for each MRB involved in the multicast session. The LCID information may further include, for each LCID, a list QFI(s) associated with the respective MRB.

At 760, gNB 2 transmits, and gNB 1 receives LCID information of cell 2 in association with the multicast service A. In general, gNB 2 may transmit the LCID information to each neighboring cell of gNB 2. The LCID information may include, for each multicast session (e.g., the multicast service A) at gNB 2, a list of LCID(s) for each MRB involved in the multicast session. The LCID information may further include, for each LCID, a list QFI(s) associated with the respective MRB.

In one example, gNB 1 may transmit the LCID information of cell 1 at 750 as part of an XN setup request. In response, gNB 2 may transmit the LCID information of cell 2 at 760 as part of an XN setup response. In some examples, gNB 1 may transmit an update about its LCID information. Similarly, gNB 2 may transmit an update about its LCID information. and/or a RAN configuration update. In such examples, gNB 1 may transmit the LCID information of cell 1 at 750 as part of a RAN configuration update message. Similarly, gNB 2 may transmit the LCID information of cell 2 at 760 as part of a RAN configuration update message.

At 770, gNB 1 may determine a mapping between its own LCID(s) to cell 2's LCID(s) based on the LCDI information received at 760. At 780, gNB 2 may determine a mapping between its own LCID(s) to cell 1's LCID(s) based on the LCDI information received at 750.

As an example, at 750, gNB 1 may indicate that MRB 1 is associated with the multicast service, and LCID 3 is associated with QFI 1 and QFI 2 for the multicast service A. At 760, gNB 2 may indicate that MRB 2 is associated with the multicast service, and LCID 5 is associated with QFI 1 and QFI 2 for the multicast service A at 760. As such, at 770, gNB 1 may determine that MRB 1 of gNB 1 is mapped to MRB 2 of gNB 2, and LCID 3 of gNB 1 is mapped to LCID 5 of gNB 2 in association with the multicast service A. At 780, gNB 2 may determine that MRB 2 of gNB 2 is mapped to MRB 1 of gNB 1, and LCID 5 of gNB 2 is mapped to LCID 3 of gNB 1 in association with the multicast service A

Subsequently, gNB 1 may transmit an indication of a PDCP counter synchronization among gNBs of a PLMN, where the indication may include the mapping determined at 770 to facilitate multicast service continuity for RRC inactive UE in mobility using substantially similar mechanisms as discussed above with reference to FIGS. 5 and 6. Similarly, gNB 2 may transmit an indication of a PDCP counter synchronization among gNBs of a PLMN, where the indication may include the mapping determined at 780 to facilitate multicast service continuity for RRC inactive UE in mobility using substantially similar mechanisms as discussed above with reference to FIGS. 5 and 6.

The examples of FIGS. 5-7 are merely illustrative. In embodiments, the number of neighboring cells and the number of UEs within a cell receiving multicast service may vary and may be different from those illustrated in FIGS. 5-7.

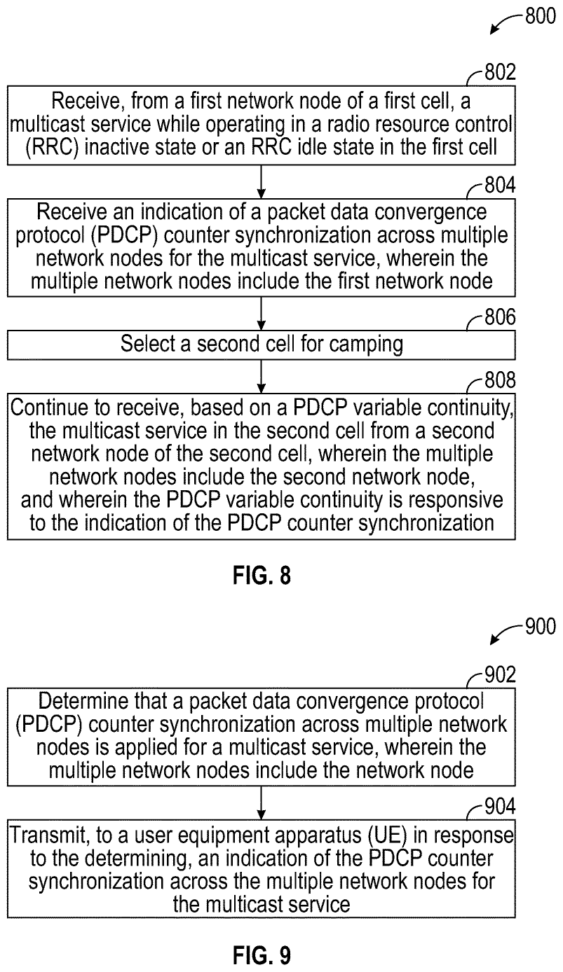

FIG. 8 is a flow diagram of example operations of a UE for multicast service continuity, according to one illustrated aspect of the present disclosure. The UE may be similar to the UE 150, 210, 310, and/or the UE discussed above with reference FIGS. 5-6. In some examples, the UE may implement the operations using an apparatus with components as shown in FIG. 10. The operations of FIG. 8 may include similar mechanisms as discussed above with reference to FIGS. 3-7. As illustrated, FIG. 8 includes a number of enumerated steps, but aspects of the operations in FIG. 8 may include additional steps before, after, and in between the enumerated steps. In some aspects, one or more of the enumerated steps may be omitted or performed in a different order.

At 802, the operations include receiving, from a first network node of a first cell, a multicast service while operating in an RRC inactive state or an RRC idle state in the first cell. The first network node may be similar to the network nodes 120, 320, 330, network nodes of the PCell 222, SCell 224, PCell 232, and SCell 234, and/or gNB1 and gNB2 discussed above with reference FIGS. 5-7. The first cell may be similar to the cell 302, 304, and/or cell 1 and cell 2 discussed above with reference FIGS. 5-7

At 804, the operations include receiving an indication of a PDCP counter synchronization across multiple network nodes for the multicast service, where the multiple network nodes include the first network node.

In an aspect, the receiving the indication of the PDCP counter synchronization includes receiving an indication of an LCID mapping between at least the first network node and the second network node for the multicast service. The indication of the LCID mapping is the indication of the PDCP counter synchronization and implicitly indicates the PDCP counter synchronization across the multiple network nodes.

In an aspect, the receiving the indication of the PDCP counter synchronization includes receiving, from the first network node before the selecting, the indication of the PDCP counter synchronization. In an aspect, the receiving the indication of the PDCP counter synchronization includes receiving, from the second network node after the reselecting, the indication of the PDCP counter synchronization. In an aspect, the receiving the indication of the PDCP counter synchronization includes receiving the indication of the PDCP counter synchronization in an RRC release message. In an aspect, the receiving the indication of the PDCP counter synchronization includes receiving the indication of the PDCP counter synchronization in a MCCH configuration.

At 806, the operations include selecting a second cell for camping. The second cell may be similar to the cell 302, 304, and/or cell 1 and cell 2 discussed above with reference FIGS. 5-7.

At 808, the operations include continuing to receive, based on a PDCP variable continuity, the multicast service in the second cell from a second network node of the second cell, where the multiple network nodes include the second network node, and where the PDCP variable continuity is responsive to the indication of the PDCP counter synchronization. The second network node may be similar to the network nodes 120, 320, 330, network nodes of the PCell 222, SCell 224, PCell 232, and SCell 234, and/or gNB1 and gNB2 discussed above with reference FIGS. 5-7. In an aspect, the PDCP variable continuity may refer to the UE continuing to track a PDCP counter for data packets of the multicast service received in the second cell based on a last PDCP counter received in the first cell. In general, the PDCP variable continuity may refer to the UE using a variable of a PDCP context (or PDCP entity) while operating in the first cell and continuing to use the same PDCP variable while operating in the second cell without resetting the value of the PDCP variable.

In an aspect, the continuing to receive the multicast service in the second cell includes refraining, in response to the indication of the PDCP counter synchronization, from performing a PDCP re-establishment in the second cell in association with the multicast service.

In an aspect, when the indication of the PDCP counter synchronization at 802 includes the LCID mapping indicating that, for the multicast service, a first LCID value associated with the first network node is mapped to a second LCID value associated with the second network node, and the continuing to receive the multicast service in the second cell at 808 includes receiving the multicast service via a logical channel identified by the second LCID value. Further, the continuing to receive the multicast service in the second cell at 808 includes applying, in response to receiving the LCID mapping, a PDCP counter of the first cell in the second cell to receive the multicast service.

In an aspect, the UE further determines, in response to the indication of the PDCP counter synchronization, the PDCP variable continuity.

FIG. 9 is a flow diagram of example operations of a network node for multicast service continuity, according to one illustrated aspect of the present disclosure. The network node may be similar to the network nodes 120, 320, 330, network nodes of the PCell 222, SCell 224, PCell 232, and SCell 234, and/or gNB1 and gNB2 discussed above with reference FIGS. 5-7. In some examples, the network node may implement the operations using an apparatus with components as shown in FIG. 10. The operations of FIG. 9 may include similar mechanisms as discussed above with reference to FIGS. 3-7. As illustrated, FIG. 9 includes a number of enumerated steps, but aspects of the operations in FIG. 9 may include additional steps before, after, and in between the enumerated steps. In some aspects, one or more of the enumerated steps may be omitted or performed in a different order.

At 902, the operations include determining that a PDCP counter synchronization across multiple network nodes is applied for a multicast service, where the multiple network nodes include the network node.

In an aspect, the transmitting the indication of the PDCP counter synchronization includes transmitting an indication of an LCID mapping between the network node and at least another network node of the multiple network nodes for the multicast service. In an aspect, the UE determines, for the multicast service, an LCID mapping between the network node and the other network node.

At 904, the operations include transmitting, to the UE 150 in response to the determining, an indication of the PDCP counter synchronization across the multiple network nodes for the multicast service.

In an aspect, the UE further exchanges, with another network node of the multiple network nodes (e.g., via an Xn interface), LCID information associated with the multicast service. In an aspect, the LCID information includes an indication of one or more QFIs mapped to an individual LCID associated with the multicast service.

In an aspect, the exchanging the LCID information associated with the multicast service includes transmitting, to the other network node, LCID information of the network node in association with the multicast service, and receiving, from the other network node, LCID information of the other network node in association with the multicast service. In an aspect, the transmitting the LCID information of the network node is responsive to the receiving the LCID information of the other network node. In an aspect, the receiving the LCID information of the other network node is responsive to the transmitting the LCID information of the network node.

In an aspect, the transmitting the indication of the PDCP counter synchronization includes transmitting, to the UE, the indication of the PDCP counter synchronization in an RRC release message. In an aspect, the transmitting the indication of the PDCP counter synchronization includes transmitting, to the UE, the indication of the PDCP counter synchronization in a MCCH configuration.

FIG. 10 illustrates an example embodiment of a block diagram of example components of a UE or of a network apparatus (or network node). For instance, the UE may correspond to the UE 150, 210, 310, and/or the UE discussed above with reference FIGS. 5-6, and the network apparatus may correspond to the network nodes 120, 320, 330, network nodes of the PCell 222, SCell 224, PCell 232, and SCell 234, and/or gNB1 and gNB2 discussed above with reference FIGS. 5-7. The apparatus includes an electronic storage 1110, a processor 1120, a memory 1150, and a network interface 1140. The various components may be communicatively coupled with each other. The processor 1120 may be and may include any type of processor, such as a single-core central processing unit (CPU), a multi-core CPU, a microprocessor, a digital signal processor (DSP), a System-on-Chip (SoC), or any other type of processor. The memory 1150 may be a volatile type of memory, e.g., RAM, or a non-volatile type of memory, e.g., NAND flash memory. The memory 1150 includes computer-readable instructions that are executable by the processor 1120 to cause the apparatus to perform various operations, including an indication of a PDCP counter synchronization (e.g., including LCID mapping information across cell(s) in association with a multicast service) and/or operations related to multicast service continuity for RRC inactive UE and/or RRC idle UE in mobility as discussed herein.

The electronic storage 1110 may be and include any type of electronic storage used for storing data, such as hard disk drive, solid state drive, and/or optical disc, among other types of electronic storage. The electronic storage 1110 stores software instructions for causing the apparatus to perform its operations and stores data associated with such operations, such as storing data relating to 5G NR standards, among other data. The network interface 1140 may implement wireless networking technologies such as 5G NR, Wi-Fi 6, and/or other wireless networking technologies, and may include one or more arrays of radiating elements, such as those described in connection with FIGS. 1-9.

The components shown in FIG. 10 are merely examples, and persons skilled in the art will understand that an apparatus includes other components not illustrated and may include multiples of any of the illustrated components. Such and other embodiments are contemplated to be within the scope of the present disclosure.

Further embodiments of the present disclosure include the following examples.

Example 1 includes a method performed by a user equipment apparatus, the method including receiving, from a first network node (e.g., gNB1) of a first cell, a multicast service while operating in a radio resource control (RRC) inactive state in the first cell; receiving an indication of a packet data convergence protocol (PDCP) counter synchronization across multiple network nodes for the multicast service, where the multiple network nodes include the first network node; selecting a second cell for camping; and continuing to receive, based on a PDCP variable continuity, the multicast service in the second cell from a second network node (e.g., gNB2) of the second cell, where the multiple network nodes include the second network node, and where the PDCP variable continuity is responsive to the indication of the PDCP counter synchronization.

In Example 2, the method of example 1 can optionally include where the continuing to receive the multicast service in the second cell includes refraining, in response to the indication of the PDCP counter synchronization, from performing a PDCP re-establishment in the second cell in association with the multicast service.

In Example 3, the method of any one of examples 1-2 can optionally include further including determining, in response to the indication of the PDCP counter synchronization, the PDCP variable continuity, and wherein the continuing to receive the multicast service in the second cell includes receiving a packet associated with the multicast service by applying the determined PDCP variable continuity.

In Example 4, the method any one of examples 1-3 can optionally include where the receiving the indication of the PDCP counter synchronization includes receiving an indication of a logical channel identifier (LCID) mapping between at least the first network node and the second network node for the multicast service.

In Example 5, the method of any one of examples 1-4 can optionally include where the indication of the LCID mapping indicates that, for the multicast service, a first LCID value associated with the first network node is mapped to a second LCID value associated with the second network node, and where continuing to receive the multicast service in the second cell includes receiving the multicast service via a logical channel identified by the second LCID value. The indication of the LCID mapping is the indication of the PDCP counter synchronization and implicitly indicates the PDCP counter synchronization across the multiple network nodes. The continuing to receive the multicast service in the second cell can optionally include applying, in response to receiving the LCID mapping, a PDCP counter of the first cell in the second cell to receive the multicast service.

In Example 6, the method of any one of examples 1-5 can optionally include where the receiving the indication of the PDCP counter synchronization includes receiving, from the first network node before the reselecting, the indication of the PDCP counter synchronization.

In Example 7, the method of any one of examples 1-6 can optionally include where the receiving the indication of the PDCP counter synchronization includes receiving, from the second network node after the reselecting, the indication of the PDCP counter synchronization.

In Example 8, the method of any one of examples 1-7 can optionally include where the receiving the indication of the PDCP counter synchronization includes receiving the indication of the PDCP counter synchronization in an RRC release message.

In Example 9, the method of any one of examples 1-8 can optionally include where the receiving the indication of the PDCP counter synchronization includes receiving the indication of the PDCP counter synchronization in a multicast control channel (MCCH) configuration.

Example 10 includes an apparatus including at least one processor; and at least one memory storing instructions which, when executed by the at least one processor, cause the network apparatus at least to perform the method of any one of examples 1-9.

Example 11 includes an apparatus including means at least to perform the method of any one of examples 1-9.

Example 12 includes a non-transitory computer-readable medium including program code, which when executed by one or more processors, causes the one or more processors to at least to perform the method of any one of examples 1-9.

Example 13 includes a method performed by a network node, the method including determining that a packet data convergence protocol (PDCP) counter synchronization across multiple network nodes is applied for a multicast service, where the multiple network nodes include the network node; and transmitting, to a user equipment apparatus (UE) in response to the determining, an indication of the PDCP counter synchronization across the multiple network nodes for the multicast service.

In Example 14, the method of example 13 can optionally include where the transmitting the indication of the PDCP counter synchronization includes transmitting an indication of a logical channel identifier (LCID) mapping between the network node and at least another network node of the multiple network nodes for the multicast service.

In Example 15, the method of any one of examples 13-14 can optionally include determining, for the multicast service, an LCID mapping between the network node and the other network node.

In Example 16, the method any one of examples 13-15 can optionally include exchanging, with another network node of the multiple network nodes (e.g., via an Xn interface), logical channel identifier (LCID) information associated with the multicast service.

In Example 17, the method of any one of examples 13-16 can optionally include where the LCID information includes an indication of one or more quality of service flow identifiers (QFIs) mapped to an individual LCID associated with the multicast service.

In Example 18, the method of any one of examples 13-17 can optionally include where the exchanging the LCID information associated with the multicast service including transmitting, to the other network node, LCID information of the network node in association with the multicast service; and receiving, from the other network node, LCID information of the other network node in association with the multicast service.

In Example 19, the method of any one of examples 13-18 can optionally include where the transmitting the LCID information of the network node is responsive to the receiving the LCID information of the other network node.

In Example 20, the method of any one of examples 13-19 can optionally include where the receiving the LCID information of the other network node is responsive to the transmitting the LCID information of the network node.

In Example 21, the method of any one of examples 13-20 can optionally include where the transmitting the indication of the PDCP counter synchronization includes transmitting, to the UE, the indication of the PDCP counter synchronization in an RRC release message.

In Example 22, the method of any one of examples 13-21 can optionally include where the transmitting the indication of the PDCP counter synchronization includes transmitting, to the UE, the indication of the PDCP counter synchronization in a multicast control channel (MCCH) configuration.

Example 23 includes an apparatus including at least one processor; and at least one memory storing instructions which, when executed by the at least one processor, cause the network apparatus at least to perform the method of any one of examples 13-23.

Example 24 includes an apparatus including means at least to perform the method of any one of examples 13-22.

Example 25 includes a non-transitory computer-readable medium including program code, which when executed by one or more processors, causes the one or more processors to at least to perform the method of any one of examples 13-22.

The embodiments and aspects disclosed herein are examples of the present disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an aspect,” “in aspects,” “in various aspects,” “in some aspects,” or “in other aspects” may each refer to one or more of the same or different aspects in accordance with this present disclosure. The phrase “a plurality of” may refer to two or more.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, Python, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

While aspects of the present disclosure have been shown in the drawings, it is not intended that the present disclosure be limited thereto, as it is intended that the present disclosure be as broad in scope as the art will allow and that the specification be read likewise. Therefore, the above description should not be construed as limiting, but merely as exemplifications of particular aspects. Those skilled in the art will envision other modifications within the scope and spirit of the claims appended hereto.

1. A user equipment apparatus comprising:
at least one processor; and
at least one memory storing instructions which, when executed by the at least one processor, cause the user equipment apparatus at least to:
receive, from a first network node of a first cell, a multicast service while operating in a radio resource control (RRC) inactive or an RRC idle state in the first cell;
receive, from the first network node in a radio resource control release message, an indication of a packet data convergence protocol (PDCP) counter synchronization across multiple network nodes for the multicast service, wherein the multiple network nodes include the first network node and at least a second network node of a second cell;
select the second cell for camping; and
continue to receive, based on a PDCP variable continuity, the multicast service in the second cell from the second network node of the second cell and refrain from performing an initialization of PDCP state variables in the second cell in association with the multicast service, wherein the PDCP variable continuity is responsive to the indication of the PDCP counter synchronization.

2. The user equipment apparatus of claim 1,
wherein the instructions when executed by the at least one processor, further cause the user equipment apparatus at least to:
determine, in response to the indication of the PDCP counter synchronization, the PDCP variable continuity; and
wherein the instructions when executed by the at least one processor, cause the user equipment apparatus at least to continue to receive the multicast service by applying the determined PDCP variable continuity to receive a packet associated with the multicast service in the second cell.

3. The user equipment apparatus of claim 1, wherein the instructions when executed by the at least one processor, cause the user equipment apparatus at least to receive the indication of the PDCP counter synchronization by:
receiving an indication of a logical channel identifier (LCID) mapping between at least the first network node and the second network node for the multicast service.

4. The user equipment apparatus of claim 3,
wherein the indication of the LCID mapping indicates that a first LCID value associated with the first network node is mapped to a second LCID value associated with the second network node, and
wherein the instructions when executed by the at least one processor, cause the user equipment apparatus at least to continue to receive the multicast service in the second cell by:
receiving the multicast service via a logical channel identified by the second LCID value.

5. The user equipment apparatus of claim 3, wherein the instructions when executed by the at least one processor, cause the user equipment apparatus at least to continue to receive the multicast service in the second cell by:
applying, in response to receiving the LCID mapping, a PDCP counter of the first cell in the second cell to receive the multicast service.

6. The user equipment apparatus of claim 1, wherein the instructions when executed by the at least one processor, cause the user equipment apparatus at least to receive the indication of the PDCP counter synchronization by:
receiving, from the first network node before the selecting, the indication of the PDCP counter synchronization.

7. A method performed by a user equipment apparatus, the method comprising:
receiving, from a first network node of a first cell, a multicast service while operating in a radio resource control (RRC) inactive state in the first cell;
receiving, from the first network node in a radio resource control release message, an indication of a packet data convergence protocol (PDCP) counter synchronization across multiple network nodes for the multicast service, wherein the multiple network nodes include the first network node and at least a second network node of a second cell;
selecting the second cell for camping; and
continuing to receive, based on a PDCP variable continuity, the multicast service in the second cell from the second network node of the second cell and refraining from performing an initialization of PDCP state variables in the second cell in association with the multicast service, and wherein the PDCP variable continuity is responsive to the indication of the PDCP counter synchronization.

8. The method of claim 7, further comprising:
determining, in response to the indication of the PDCP counter synchronization, the PDCP variable continuity in the second cell; and
continuing to receive the multicast service by applying the determined PDCP variable continuity to receive a packet associated with the multicast service in the second cell.

9. The method of claim 7, wherein the receiving the indication of the PDCP counter synchronization comprises:
receiving an indication of a logical channel identifier (LCID) mapping between at least the first network node and the second network node for the multicast service.

10. The method of claim 9, wherein the indication of the LCID mapping indicates that a first LCID value associated with the first network node is mapped to a second LCID value associated with the second network node, and
wherein the continuing to receive the multicast service in the second cell comprises:
receiving the multicast service via a logical channel identified by the second LCID value.

11. The method of claim 9, wherein the continuing to receive the multicast service in the second cell comprises:
applying, in response to receiving the LCID mapping, a PDCP counter of the first cell in the second cell to receive the multicast service.

12. The method of claim 7, wherein the receiving the indication of the PDCP counter synchronization comprises:
receiving, from the first network node before the selecting, the indication of the PDCP counter synchronization.

13. A network node comprising:
at least one processor; and
at least one memory storing instructions which, when executed by the at least one processor, cause the network node at least to:
determine that a packet data convergence protocol (PDCP) counter synchronization across multiple network nodes is applied for a multicast service, wherein the multiple network nodes include the network node and at least a second network node of a second cell; and
transmit, in a radio resource control release message to a user equipment apparatus (UE) in response to the determining, an indication of the PDCP counter synchronization across the multiple network nodes for the multicast service.

14. The network node of claim 13, wherein the instructions when executed by the at least one processor, cause the network node at least to transmit the indication of the PDCP counter synchronization by:
transmitting an indication of a logical channel identifier (LCID) mapping between the network node and at least another network node of the multiple network nodes for the multicast service.

15. The network node of claim 13, wherein the instructions when executed by the at least one processor, further cause the network node at least to:
determine, for the multicast service, an LCID mapping between the network node and the other network node.

16. The network node of claim 13, wherein the instructions when executed by the at least one processor, further cause the network node at least to:
exchange, with another network node of the multiple network nodes, logical channel identifier (LCID) information associated with the multicast service.

17. The network node of claim 16, wherein the LCID information includes an indication of one or more quality of service flow identifiers (QFIs) mapped to an individual LCID associated with the multicast service.

18-32. (canceled)
